(19) United States
(12) Patent Application Publication
(10) Pub. No.: US 2012/0331209 A1
(43) Pub. Date: Dec. 27, 2012

(54) SEMICONDUCTOR STORAGE SYSTEM

(76) Inventor: SEONG-NAM KWON, (US)

(21) Appl. No.: 13/470,878

(22) Filed: May 14, 2012

(30) Foreign Application Priority Data
Jun. 24, 2011 (KR) 10-2011-0061794

(51) Int. Cl. G06F 12/00

(52) U.S. Cl. 711/103; 711/E12.008

(57) ABSTRACT

A semiconductor storage system includes a plurality of buffer areas for receiving data from an external source via a first interface unit. A storage unit stores the data by writing the data received from the plurality of buffer areas via a second interface unit. A processor controls the plurality of buffer areas and the storage and includes a first processor controlling the first interface unit, and a second processor controlling the second interface unit. The first processor includes a delay unit delaying a time at which the plurality of buffer areas receives the data from the external source via the first interface unit. The time functions as a delay time corresponding to a difference between a data reception speed of the plurality of buffer areas via the first interface unit and a data reception speed of the storage via the second interface unit.

### CROSS-REFERENCE TO RELATED APPLICATIONS

This application claims the benefit of Korean Patent Application No. 10-2011-0061794, filed on Jun. 24, 2011, in the Korean Intellectual Property Office, the disclosure of which is incorporated herein in its entirety by reference.

### TECHNICAL FIELD

The inventive concept relates to semiconductors, and more particularly, to a semiconductor storage system.

### DISCUSSION OF THE RELATED ART

As the speed of a large capacity data storage apparatus is generally significantly slower than a transmission speed of a host computer, a buffer space is often arranged in the large capacity storage apparatus to partially compensate for the difference between the speeds. However, there is a physical limit to how much data may be stored in a buffer space. Thus, due to the limit, a user of the host computer may, at times, experience long input times characterized by a decrease in host computer performance.

### SUMMARY

The inventive concept provides a semiconductor storage apparatus and a system comprising the same to mitigate a delay of an input time.

According to an aspect of the inventive concept, there is provided a semiconductor storage system including a plurality of buffer areas for receiving data from an external source via a first interface unit. A storage stores the data by writing the data received from the plurality of buffer areas via a second interface unit. A processor controls the plurality of buffer areas and the storage and includes a first processor for controlling the first interface unit and a second processor for controlling the second interface unit. The first processor further includes a delay unit for delaying a time at which the plurality of buffer areas receives the data from the external source via the first interface unit. The time at which the buffer areas receive the data functions as a delay time corresponding to a difference between a data reception speed of the plurality of buffer areas via the first interface unit and a data reception speed of the storage via the second interface unit.

The processor may include a prediction unit for predicting time to be taken by the storage to write the data received from the plurality of buffer areas.

When deviation of the predicted time is equal to or greater than a reference value, the delay unit may allow data to be received from the external source after a delay time corresponding to the reference value.

The reference value may include two or more reference values and the delay time may vary according to the reference value.

The processor may include a counter for counting the number of buffer areas to which no data is written, where the buffer areas are from among the plurality of buffer areas.

The second processor may include a measurement unit for measuring a data exchange time between the plurality of buffer areas and the storage.

When deviation of time measured by the measurement unit is equal to or greater than a predetermined value, the processor may control data to be received from the external source after a delay time corresponding to the predetermined value.

When deviation of time measured by the measurement unit is increased, the processor may control the plurality of buffer areas to delay a time for receiving data from the external source by a time calculated based on the increased deviation.

The semiconductor storage system may be used in a real-time application.

The storage may include a solid state drive (SSD) or a hard disk drive (HDD).

The processor may delete the data from the plurality of buffer areas after the data is stored in the storage.

According to an aspect of the inventive concept, there is provided a semiconductor storage system including a plurality of buffer areas for receiving data from an external source via a first interface unit. A storage stores the data by writing the data received from the plurality of buffer areas via a second interface unit. A processor controls the plurality of buffer areas and the storage and controls the first interface unit and the second interface unit. The processor further includes a delay unit for delaying a time at which the plurality of buffer areas receives the data from the external source via the first interface unit. The time functions as a delay time corresponding to a difference between a data reception speed of the plurality of buffer areas via the first interface unit and a data reception speed of the storage via the second interface unit.

The processor may include a prediction unit for predicting times to be taken by the storage to write the data received from the plurality of buffer areas.

When deviation of the predicted time is equal to or greater than a reference value, the delay unit may allow data to be received from the external source after a delay time corresponding to the reference value.

The processor may include a counter for counting the number of buffer areas to which no data is written, wherein the buffer areas are from among the plurality of buffer areas.

The processor may include a measurement unit for measuring a data exchange time between the plurality of buffer areas and the storage.

A system for storing data includes a first interface unit receiving data from an external source and sending the received data to a plurality of buffers. A first processor controls the first interface unit. A second interface unit receives the data from the plurality of buffers and writes the received data to a storage area. A second processor controls the second interface unit. The first processor includes a delay unit for delaying the sending of the received data to a plurality of buffers by a length of time that corresponds to a difference between a speed by which the data is written to the storage unit and a speed by which the data is received by the external source.

The delay unit may delay the sending of the received data to the plurality of buffers by controlling the first interface unit. The length of time of the delay may be calculated to equalize the speed by which the data is written to the storage unit and a speed by which the data is received by the external source. The speed by which the data is written to the storage unit may be predicted by a prediction unit of the first processor. The speed by which the data is received by the external source may be measured by a measurement unit of the second processor.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a semiconductor storage system according to an exemplary embodiment of the inventive concept;

FIG. 2 is a block diagram of a semiconductor storage system according to an exemplary embodiment of the inventive concept;

FIG. 3 is a timing diagram illustrating times at which buffer areas receive data from an external device, when a delay time is not added;

FIG. 4 is a timing diagram illustrating a time taken to write data, which has been received by buffer areas, to a storage;

FIG. 5 is a timing diagram illustrating data transaction in each buffer;

FIG. 6 is a timing diagram illustrating a case in which a delay time is added to delay a time at which data is received from an external device, according to an exemplary embodiment of the inventive concept;

FIG. 7 is a timing diagram illustrating a data transaction status for each buffer when the delay time is added in the manner illustrated in FIG. 6;

FIG. 8 is a timing diagram illustrating times at which the buffer areas receive data from the external device, when a delay time is not added;

FIG. 9 is a timing diagram illustrating a time taken to write data, which has been received by the buffer areas, to the storage;

FIG. 10 is a timing diagram illustrating data transaction in each buffer;

FIG. 11 is a timing diagram illustrating a case in which a delay time is regularly added to delay a time at which data is received from the external device, according to an exemplary embodiment of the inventive concept;

FIG. 12 is a timing diagram illustrating a data transaction status for each buffer when the delay time is regularly added in the manner illustrated in FIG. 11;

FIG. 13 is a timing diagram illustrating times at which the buffer areas receive data from the external device, when the delay time is not added;

FIG. 14 is a timing diagram illustrating a time taken to write data, which has been received by buffer areas, to the storage;

FIG. 15 is a timing diagram illustrating data transaction in each buffer;

FIG. 16 is a timing diagram illustrating a case where a time at which data is received from the external device is increased by a time T0.5 from a time T4, according to an exemplary embodiment of the inventive concept;

FIG. 17 is a timing diagram illustrating a data transaction status for each buffer when the delay time is increased in the manner illustrated in FIG. 16;

FIG. 18 is a diagram illustrating the semiconductor storage system of FIG. 1 where the semiconductor storage system is a NAND flash memory system according to an exemplary embodiment of the inventive concept; and

FIG. 19 is a block diagram illustrating a computing system according to an exemplary embodiment of the inventive concept.

### DETAILED DESCRIPTION

Hereinafter, exemplary embodiments of the inventive concept will be described in detail with reference to the attached drawings. Like reference numerals in the drawings may denote like elements throughout.

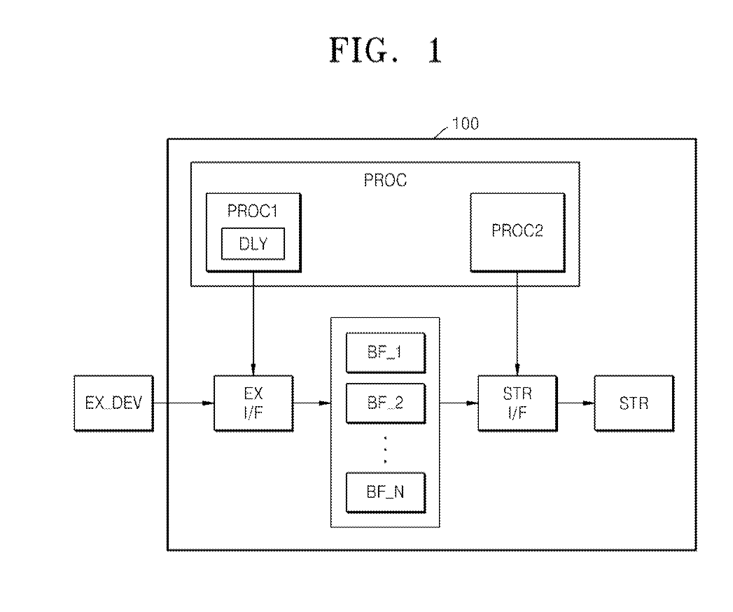

FIG. 1 is a block diagram of a semiconductor storage system 100 according to an exemplary embodiment of the inventive concept.

Referring to FIG. 1, the semiconductor storage system 100 includes a storage STR, a plurality of buffer areas BF_1, BF_2, . . . BF_N, a processor PROC, a first interface unit EX_I/F, and a second interface unit STR_I/F. The processor PROC includes a first processor PROC1 and a second processor PROC2. The first processor PROC1 includes a delay unit DLY.

The semiconductor storage system 100 may be a NAND flash memory system but is not limited thereto and may be a random access memory (RAM), a read only memory (ROM), a dynamic random access memory (DRAM), a synchronous dynamic random access memory (SDRAM), or a NOR flash memory. Alternatively, the semiconductor storage system may be a large capacity storage apparatuses such as a solid state drive (SSD), a hard disk drive (HDD), and the like, which may be provided as internal semiconductor integrated circuits in a computer or other electronic devices.

The storage STR may be a physical storage space for writing data. For example, in a case where the semiconductor storage system 100 is the NAND flash memory system, the storage STR may be a memory array.

An external device EX_DEV may include a personal computer (PC), a personal digital assistant (PDA), a tablet PC, a laptop computer, and/or other portable terminals. Also, the external device EX_DEV may be referred to herein as a host or host computer.

A speed by which data is written from the external device EX_DEV to a buffer BF is fast with respect to a speed by which data is written from the buffer BF to the storage STR. Accordingly, the buffer BF may become full of data so that there is no more buffer space available for data to be written to. Once the buffer has become full, the semiconductor storage system 100 may operate as if a buffer were not there. For example, in the semiconductor storage system 100 having 1.6 million buffer areas, if data is written from the external device EX_DEV to 200,000 buffer areas per one second on average, and data is written from 40,000 buffer areas to the storage STR per one second on average, 160,000 buffer areas are filled per one second. Thus, if data is continually received from an external source for 10 seconds, after 10 seconds, a data input speed from the external source may become about 5 times slower than usual. For example, the data input speed becomes as slow as a speed for writing data to a storage, for example, by a speed for filling 40,000 buffer areas per one second. In this event, a user may feel as if the semiconductor storage system 100 was not functioning.

In the semiconductor storage system 100 according to an exemplary embodiment, the first processor PROC1 includes the delay unit DLY. In a case where a large amount of information has to be written at one time, the delay unit DLY delays the writing of the data from the host to the buffer BF. For example, in the aforementioned case, a delay time is added to allow data to be written to 120,000 buffer areas per one second on average from the beginning. Thus, while data is continually received from the external source for 20 seconds, the user does not feel a change in the data input speed of the semiconductor storage system 100 and feels that the semiconductor storage system 100 normally operates. Accordingly, an input time may be averaged and the user may not feel as if the semiconductor storage system 100 were suddenly stopped. Detailed descriptions thereof will be provided below. Thus while exemplary embodiments of the present invention might not reduce the total time it takes for a given operation to be performed, the speed at which the operation is to be performed may be balanced to avoid an abrupt reduction in speed, which may be perceived by the user as a malfunction.

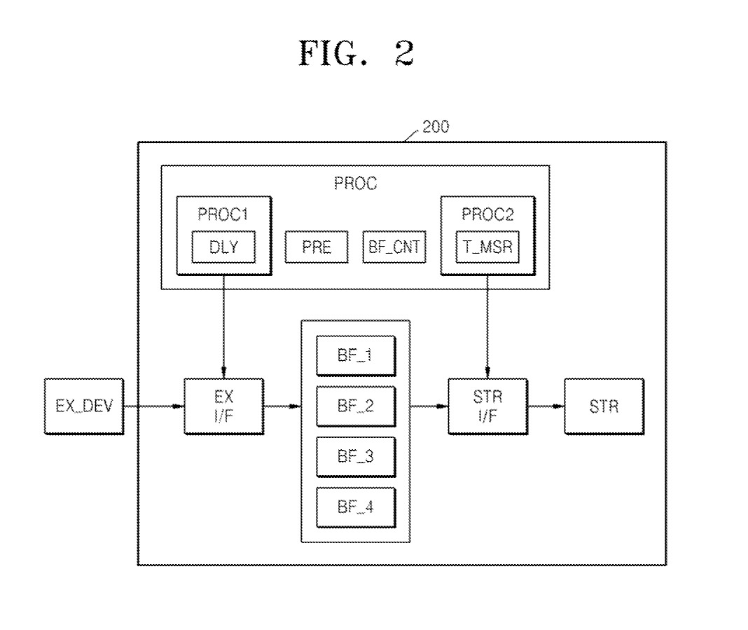

FIG. 2 is a block diagram of a semiconductor storage system 200 according to an exemplary embodiment of the inventive concept.

Referring to FIG. 2, a processor PROC may include a prediction unit PRE and a counter BF_CNT. A first processor PROC 1 may include the delay unit DLY. A second processor PROC2 may include a measurement unit T_MSR.

The prediction unit PRE may predict a next time to write data to a storage STR, based on a time measured by the measurement unit T_MSR, the number of vacant buffer areas counted by the counter BF_CNT, and/or a command from the semiconductor storage system 200. The prediction unit PRE may predict the next time by performing a static analysis and/or measurement. The static analysis involves predicting a write time by analyzing only a writing code without depending on a performance result from an actual target system or a simulator. The static analysis includes garbage collection (GC). The prediction by the measurement is performed by measuring a result with respect to an input applied to the actual target system or the simulator. According to the predicted next time, a delay unit DLY delays the receiving of the data from an external device EX_DEV to a buffer BF.

The measurement unit T_MSR measures a time to be taken to perform an operation for writing data from the buffer BF to the storage STR. In the detailed description, the measurement unit T_MSR may be referred to as a ‘time measurement unit T_MSR’. According to the time measured by the measurement unit T_MSR, the prediction unit PRE may predict a next time to perform an operation for writing data from the buffer BF to the storage STR.

For example, when a time, which is sequentially measured by the measurement unit T_MSR, for externally receiving data is increased, the prediction unit PRE may predict an increase in a time to be taken to perform an operation for writing data from the buffer BF to the storage STR, and the delay unit DLY may insert or increase a delay time. According to an exemplary embodiment, when a time, which is sequentially measured by the measurement unit T_MSR, for externally receiving data is decreased, the prediction unit PRE may predict a decrease in the time to be taken to perform the operation for writing data from the buffer BF to the storage STR and the delay unit DLY may remove or decrease the delay time.

The counter BF _CNT periodically recognizes the number of vacant buffer areas from among a plurality of buffer areas. According to the number of vacant buffer areas counted by the counter BF_CNT, the delay unit DLY may insert or remove the delay time.

For example, if the number of vacant buffer areas counted by the counter BF _CNT is decreased, the prediction unit PRE may predict the increase of the time to be taken to perform the operation for writing data from the buffer BF to the storage STR, and the processor PROC may insert or increase the delay time accordingly. Also, in an exemplary embodiment, if the number of vacant buffer areas counted by the counter BF_CNT is increased, the prediction unit PRE may predict the decrease in the time to be taken to perform the operation for writing data from the buffer BF to the storage STR, and the processor PROC may remove or decrease the delay time.

For convenience of description, the semiconductor storage system 200 is shown in FIG. 2 as includes four buffer areas BF_1, BF_2, BF_3, and BF_4. However, the number of buffer areas is shown as an example and any number of buffer areas may be used. According to system requirement, the number of buffer areas may be several tens to several billions or even more, which also applies to the descriptions of the embodiments below.

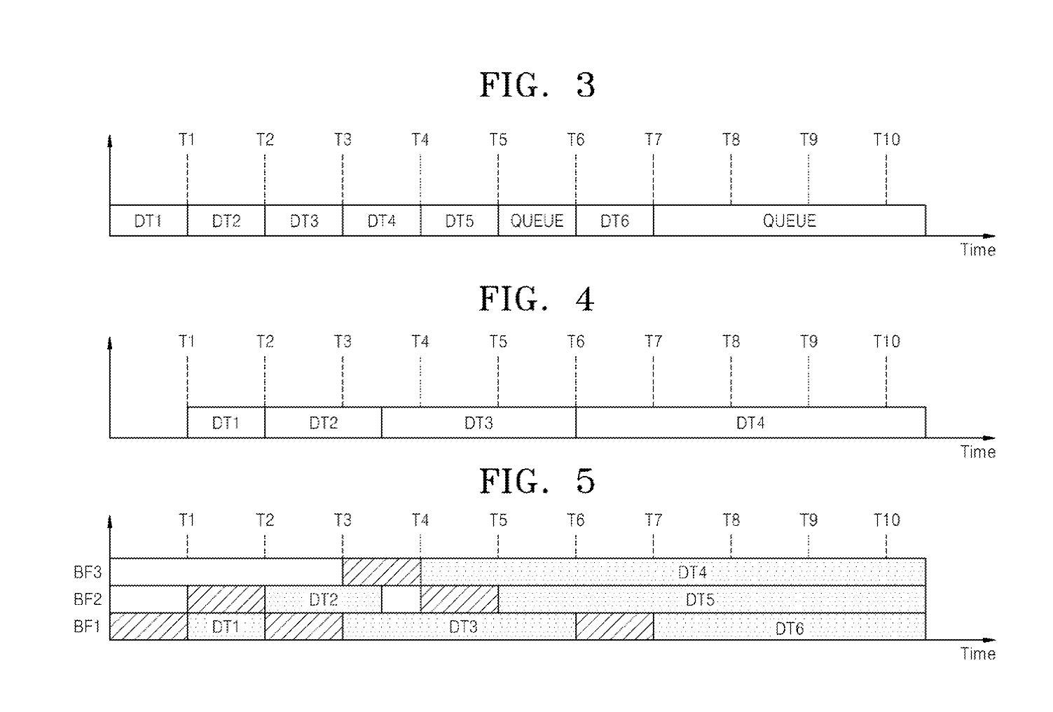

FIGS. 3 through 7 are timing diagrams illustrating cases in which the processor PROC inserts a delay time while data is received from the external device EX_DEV (e.g., a host computer) by buffer areas, when the number of buffer areas (or the number of remaining buffer areas) is 3.

FIG. 3 is a timing diagram illustrating times at which the buffer areas receive data from the external device EX_DEV, when the delay time is not added.

Referring to FIG. 3, first data DT1 is received from a zero point to a time T1. A random time in data transaction may be referred to as the zero point. Second data DT2 is received from the time T1 to a time T2. Third data DT3 is received from the time T2 to a time T3. Fourth data DT4 is received from the time T3 to a time T4. Fifth data DT5 is received from the time T4 to a time T5. From the time T5 to a time T6, data is not received from the external device EX_DEV and is queued. Sixth data DT6 is received from the time T6 to a time T7. Similar to a time period from the time T5 to the time T6, the buffer areas do not receive data beyond a time T7, thus the buffer areas stop receiving data and queue. At this time, a user of the external device EX_DEV may feel as if a system was momentarily stopped.

In the timing diagram of FIG. 3, time periods of the times T1 through T10 might not be equal to each other. A time that is approximately halfway between two referenced time points may be referred to herein by adding 0.5 to the previous reference time point. For example, time T3.5 is approximately halfway between time T3 and time T4. Also, although the number of buffer areas is shown as 3, this is for convenience of description and the number of buffer areas is not limited to a particular number.

FIG. 4 is a timing diagram illustrating a time taken to write data, which has been received by buffer areas, to the storage STR. First data DT1 is written in a buffer during a time period from a time T1 to a time T2, and is then written to the storage STR at the time T2. Thereafter, the first data DT1 is deleted from the buffer. Second data DT2 is written in a buffer during a time period from the time T2 to a time T3.5, and is then written to the storage STR at the time T3.5. Thereafter, the second data DT2 is deleted from the buffer. Third data DT3 is written in a buffer during a time period from the time T3.5 to a time T6, and is then written to the storage STR at the time T6. Thereafter, the third data DT3 is deleted from the buffer. Fourth data DT4 is written in a buffer from the time T6. For example, the first data DT1 through the fourth data DT4 are sequentially written to the storage STR. The writing times for the first through fourth data DT1-DT4 are illustrated in FIG. 4.

FIG. 5 is a timing diagram illustrating data transaction in each buffer area. A case in which data is received from the external device EX_DEV (e.g., a host) is marked by using hatched-line boxes, and a case in which data is written in a buffer is marked by using shaded boxes. When data is written to the storage STR, the data is deleted from a buffer. Hereinafter, a data transaction status for each time will now be described.

A first buffer area BF1 receives first data DT1 from a zero point to a time T1.

From the time T1 to a time T2, the first data DT1 is written in the first buffer area BF1, and a second buffer area BF2 receives second data DT2. Here, the first buffer area BF1 transmits the first data DT1 to the storage STR so that the first data DT1 is stored in the storage STR and is deleted from the first buffer area BF1. Thus, the first buffer area BF1 becomes again a buffer to which no data is written. For example, the first buffer area BF1 becomes a vacant buffer.

From the time T2 to a time T3, the second data DT2 is written in the second buffer BF2 and the first buffer BF1 receives third data DT3. Here, the second buffer BF2 transmits the second data DT2 to the storage STR so that the second data DT2 is stored in the storage STR. These operations are repeated until a time T3.5. At the time T3, data is written in the first buffer area BF1 and the second buffer area BF2, so that a third buffer area BF3 starts receiving fourth data DT4.

In this manner, data is written to the storage STR from the time T3 to a time T5.

In a time period from the time T5 to a time T6, the third data DT3 is written in the first buffer area BF1, fifth data DT5 is written in the second buffer area BF2, and the fourth data DT4 is written in the third buffer area BF3. Thereafter, there is no available space for receiving data and in order to receive data from the external device EX_DEV, new data is queued until data written to the first buffer area BF1 through the third buffer area BF3 is deleted.

In a time period from the time T6 to a time T7, the third data DT3 is completely written to the storage STR and thus is deleted from the first buffer area BF1 so that the first buffer area BF1 starts receiving sixth data DT6.

From the time T7, all of the first buffer area BF1 through the third buffer area BF3 have data written thereto and thus are not able to receive data anymore. Thus, in order to receive data from the external device EX_DEV, new data is queued until data written to the first buffer area BF1 through the third buffer area BF3 is deleted. This queue continues after a time T10 elapses, so that a user feels as if the system is malfunctioning.

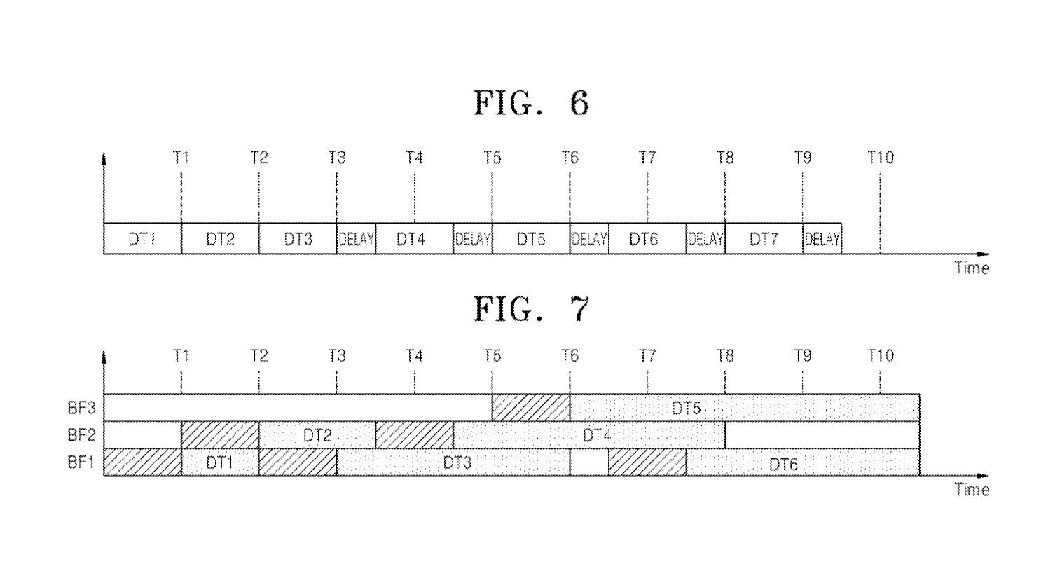

FIG. 6 is a timing diagram illustrating a case in which a delay time is added to delay a time at which data is received from an external device (e.g., a host computer), according to an exemplary embodiment of the inventive concept. FIG. 7 is a timing diagram illustrating a data transaction status for each buffer when the delay time is added in the case of FIG. 6.

Referring to FIG. 6, after third data DT3 is written to a buffer area, a delay time is added to a time at which each buffer receives data from the external device. By adding the delay time, data is written to each buffer area as illustrated in FIG. 7. For example, recording times of the third data DT3 through seventh data DT7 are regularly delayed, so that a user who externally inputs data does not feel as if a system was suddenly stopped.

Referring to FIG. 7, the deviation of input times is decreased although the same data is written from buffer areas to a storage and total writing times are on average the same.

Prediction for insertion of the delay time as in the case of FIGS. 6 and 7 may be performed by the prediction unit PRE at a time T3 when vacant buffer areas no longer exist. For example, the prediction may be performed according to the number of vacant buffer areas counted by the counter BF_CNT or a change in the number of vacant buffer areas.

According to an exemplary embodiment, in a case where the number of vacant buffer areas is decreased below a predetermined level, the delay unit DLY may insert the delay time. For example, in a case where the total number of buffer areas is 3 million (3×10⁶), if the number of vacant buffer areas is equal to or less than 300,000 (3×10⁵), the delay time may be added.

According to an exemplary embodiment, the delay unit DLY may be controlled to increase or decrease the delay time by measuring a time at which data is written to the storage STR, in consideration of the number of vacant buffer areas. For example, in a case where the total number of buffer areas is 3 million (3×10⁶), if the number of vacant buffer areas is 1 million (10⁶), a delay time of 1 μs may be added, and if the number of vacant buffer areas is 0.5 million (5×10⁵), a delay time of 2 μs may be added.

According to an exemplary embodiment, the delay unit DLY may insert a delay time in consideration of a change in the number of vacant buffer areas. For example, in a case where the total number of buffer areas is 3 million (3×10⁶), if the number of vacant buffer areas is maintained at 0.5 million (5×10⁵) and then is sharply decreased to 50,000 (5×10⁴) after 1ms (or after a predetermined time period), a delay time may be added.

According to an exemplary embodiment, the processor PROC may be controlled to increase or decrease a delay time in consideration of a change in the number of vacant buffer areas. For example, in a case where the total number of buffer areas is 3 million (3×10⁶), if the number of vacant buffer areas is maintained at 50,000 (5×10⁴) and is then suddenly decreased to 0.5 million (5×10⁵) after a predetermined time period (e.g. 1 μs), the processor PROC that has been inserting a delay time of 2 μs may insert a delay time of 1 μs. In an exemplary embodiment, in a case where the number of vacant buffer areas is sharply decreased, a delay time may be controlled to be increased.

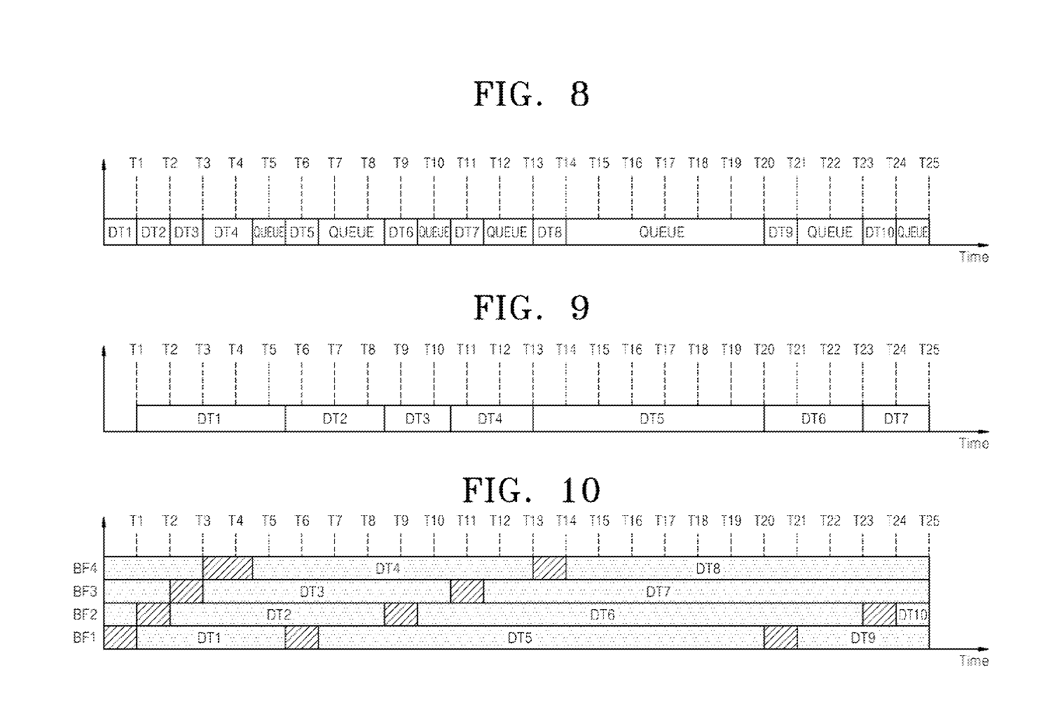

FIGS. 8 through 12 are timing diagrams illustrating cases in which the delay unit DLY inserts a delay time and then regularly inserts a delay time when the number of buffer areas (or the number of remaining buffer areas) is 4.

FIG. 8 is a timing diagram illustrating times at which the buffer areas receive data from the external device EX_DEV, when the delay time is not added.

A case of FIG. 8 may be described similarly as the case of FIG. 3. Referring to FIG. 8, first data DTI is received from a zero point to a time T1. A random time in data transaction may be referred to as the zero point. Second data DT2 is received from the time T1 to a time T2. Third data DT3 is received from the time T2 to a time T3. Fourth data DT4 is received from the time T3 to a time T4.5. From the time T4.5 to a time T5.5, external data input is stopped and then is queued. In this manner, receiving and queuing of data DT is repeated. From a time T14 to a time T20, a queue time is increased, so that a user may feel as if a system was stopped.

In the case of FIG. 8, similar to the case of FIG. 3, time periods of the times T1 through T25 might not be equal to each other. Also, although the number of buffer areas is set as 4 for convenience of description, any number of buffer areas may be used.

FIG. 9 is a timing diagram illustrating a time taken to write data, which has been received by buffer areas, to the storage STR. For example, first data DT1 through seventh data DT7 are sequentially written to the storage STR; their writing times are illustrated in FIG. 9.

FIG. 10 is a timing diagram illustrating data transaction in each buffer area.

As in the timing diagram of FIG. 5, a case in which data is received from the external device EX _DEV (e.g., a host) is marked by using hatched-line boxes, and a case in which data is written in a buffer is marked by using shaded boxes. When data is written to the storage STR, the data is deleted from a buffer area.

Unlike the case of FIG. 5, in a case of FIG. 10, at a zero point, arbitrary data is written in a buffer area BF2 through a buffer area BF4, and a buffer area BF 1 starts receiving first data DT1. Except for this feature, other features of the case of FIG. 10 in which buffer areas receive data for each time are similar to the case described above with reference to FIG. 5.

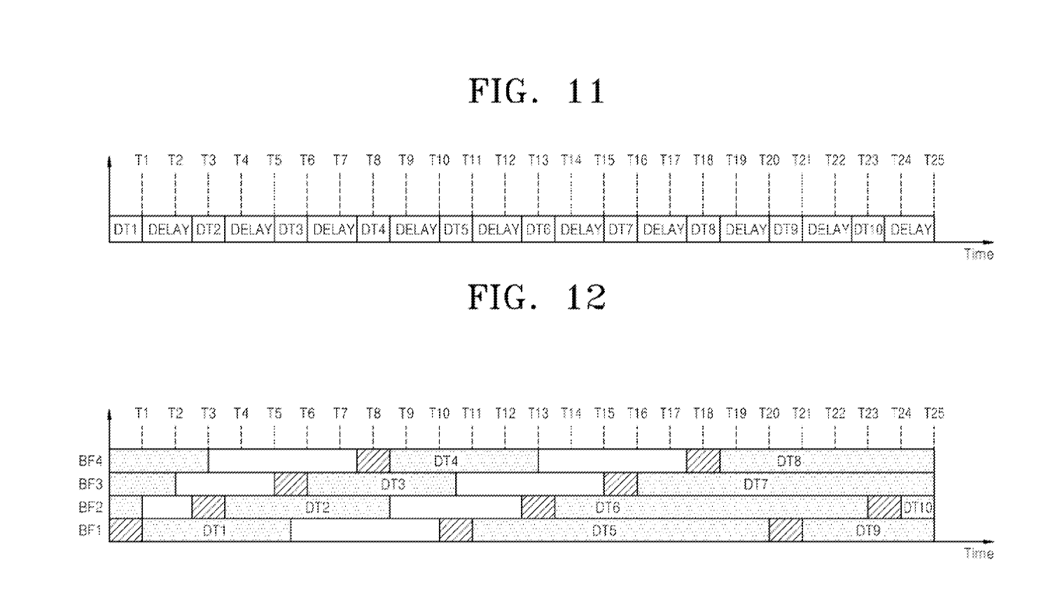

FIG. 11 is a timing diagram illustrating a case in which a delay time is regularly added to delay a time at which data is received from the external device EX _DEV (e.g., a host computer), according to an exemplary embodiment of the inventive concept. FIG. 12 is a timing diagram illustrating a data transaction status for each buffer area when the delay time is regularly added in the case of FIG. 11.

Referring to FIG. 11, the delay time is added at a zero point. By regularly inserting the delay time as in the case of FIG. 11, data is written to each buffer as illustrated in FIG. 12. For example, recording times of first data DT1 through tenth data DT10 are regularly delayed.

Referring to FIG. 12, the deviation of input times is decreased although the same data is written from buffer areas to a storage and total writing times are on average the same.

The regular insertion of the delay time as in the case of FIGS. 11 and 12 may correspond to a case in which the delay time added in the case of FIGS. 6 and 7 is maintained. When the regular insertion of the delay time is maintained, a long queue time such as a queue time of a time T14 through a time T20 may be prevented. According to an exemplary embodiment, even when the regular insertion of the delay time is maintained, the prediction unit PRE may be controlled to increase or decrease the delay time by predicting the occurrence of an input queue time.

In an exemplary embodiment, the prediction unit PRE may predict a situation such as garbage collection by analyzing a writing code. In a case where the situation is predicted, the prediction unit PRE may not delete but maintain a previously added delay time so as to allow an input time of a system not to be changed. For example, a situation of the time T14 through the time T20 may correspond to garbage collection. The prediction unit PRE may predict the situation in advance and then may insert or maintain a delay time.

In an exemplary embodiment, the prediction unit PRE may perform prediction by measuring results with respect to applied inputs. For example, if the situation of the time T14 through the time T20 is periodically repeated, the prediction unit PRE may predict this periodic situation at a time T2, and the processor PROC may have the delay time maintained.

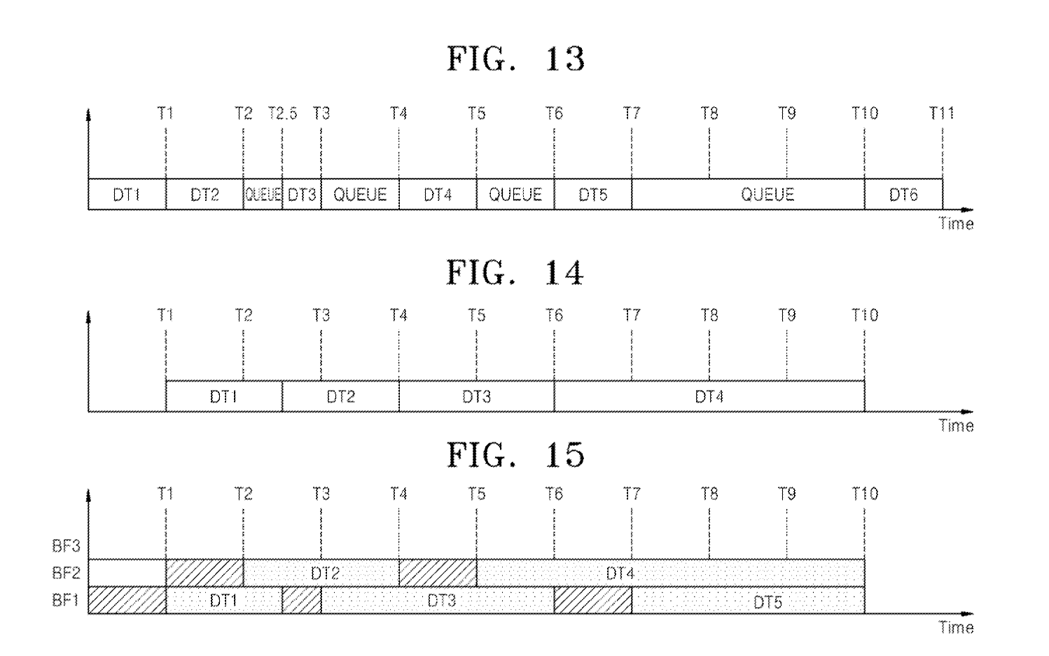

FIGS. 13 through 17 are timing diagrams illustrating cases in which a delay time is increased according to an increase of a queue time, when the number of buffer areas (or the number of remaining buffer areas) is 2.

FIG. 13 is a timing diagram illustrating times at which the buffer areas receive data from the external device EX_DEV, when the delay time is not added.

Referring to FIG. 13, first data DT1 is received from a zero point to a time T1. Similar to the cases of FIGS. 3 and 8, a random time in data transaction may be referred to as the zero point. Second data DT2 is received from the time T1 to a time T2. From the time T2 to a time T2.5, external data input is stopped and then is queued. Third data DT3 is received from the time T2.5 to a time T3. From the time T3 to a time T4, external data input is stopped and then is queued. For example, unlike the case of FIG. 3, in the case of FIG. 13, the queue time is further increased. Since the queue time is abruptly increased, in a queue time from a time T7 to a time T10, a user may feel as if a system were stopped.

In the case of FIG. 13, similar to the cases of FIGS. 3 and 8, time periods of the times T1 through T11 might not be equal to each other. Also, although the number of buffer areas is set as 2 for convenience of description, any number of buffer areas may be used.

FIG. 14 is a timing diagram illustrating a time taken to write data, which has been received by buffer areas, to the storage STR. For example, first data DT1 through sixth data DT6 are sequentially written to the storage STR, and their writing times are illustrated in FIG. 14.

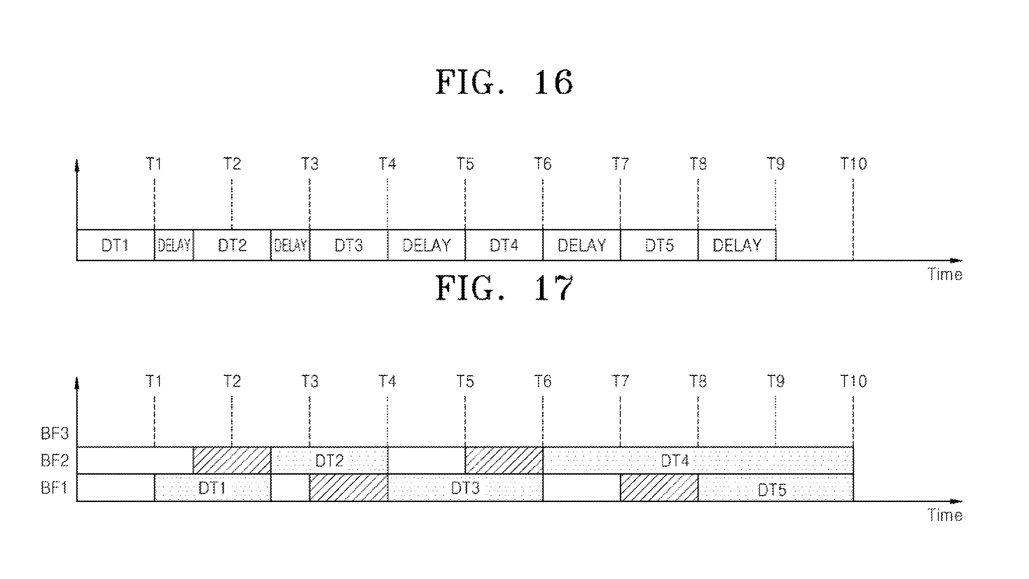

FIG. 15 is a timing diagram illustrating data transaction in each buffer area. As in the timing diagrams of FIGS. 5 and 10, a case in which data is received from the external device EX_DEV (e.g., a host) is marked by using hatched-line boxes, and a case in which data is written in a buffer is marked by using shaded boxes. When data is written to the storage STR, the data is deleted from a buffer. The timing diagram of FIG. 15 is similar to the timing diagrams of FIGS. 5 and 10 in that buffer areas receive data for each time, and the timing diagram of FIG. 15 is different from the timing diagrams of FIGS. 5 and 10 in that the timing diagram of FIG. 15 is related to a case of two buffer areas.

FIG. 16 is a timing diagram illustrating a case where a time at which data is received from the external device EX_DEV (e.g., a host computer) is increased by a time T0.5 from a time T4, according to an embodiment of the inventive concept. FIG. 17 is a timing diagram illustrating a data transaction status for each buffer when the delay time is increased in the case of FIG. 16.

Referring to FIG. 17, the deviation of input times is decreased although the same data is written from buffer areas to a storage and writing times are on average the same.

The increase of the delay time as in the case of FIGS. 16 and 17 may correspond to a case in which the delay time added in the case of FIGS. 6 and 7 is increased. When the delay time is increased, a long queue time such as a queue time of a time T7 through a time T10 may be prevented. According to an exemplary embodiment, the increase of the delay time is performed in response to an increase of a queue time. For example, the queue time elapsed for a time T0.5 from a time T2 to a time T2.5 and is increased by a time T1 from a time T3 to a time T4. The queue time is measured by the measurement unit T_MSR, and according to the increase of the queue time, the processor PROC may further insert a delay time. In response to the increase of the queue time, the delay time may be increased from the time T4. The delay time may be increased by a time T0.5, so that the deviation of input times may be decreased.

In an exemplary embodiment, a delay time may be decreased. For example, in a case where a queue time is decreased by a time T0.5, the delay time may be decreased in response to the decrease of the queue time.

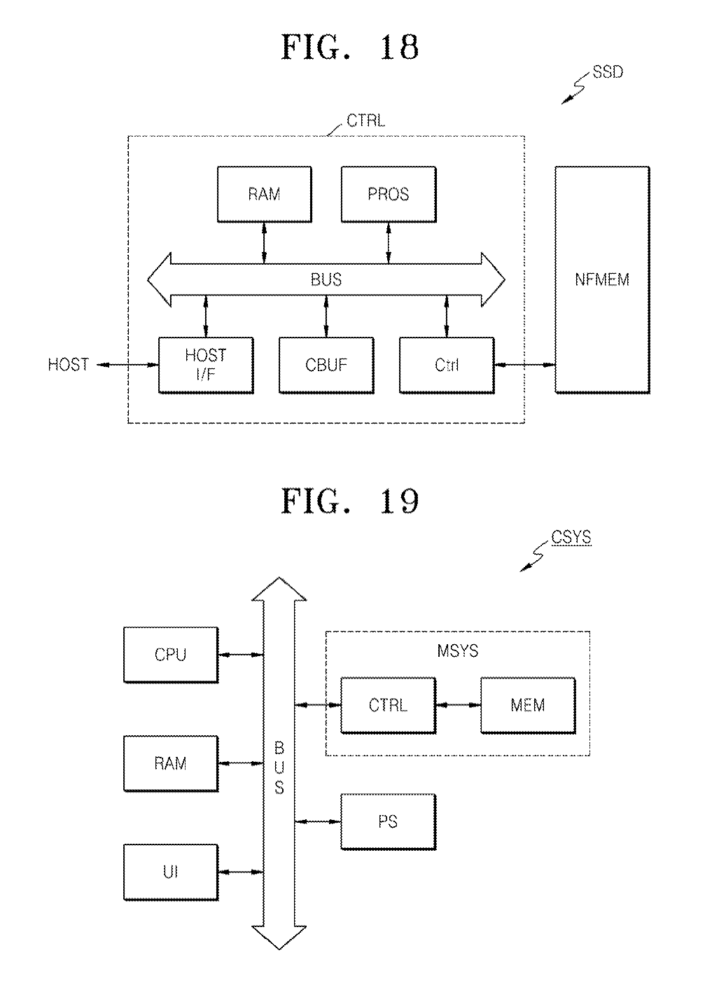

FIG. 18 is a diagram illustrating the semiconductor storage system 100 of FIG. 1 in detail when the semiconductor storage system 100 is a NAND flash memory system, according to an exemplary embodiment of the inventive concept.

Referring to FIG. 18, the NAND flash memory system according to an exemplary embodiment may include an SSD controller CTRL and a NAND flash memory NFMEM. The SSD controller CTRL may include a processor PROS, a RAM, a cache buffer CBUF, and a memory controller Ctrl that are connected to each other by an internal bus BUS. In response to a request (a command, an address, or data) from a host, the processor PROS controls the SSD controller CTRL to exchange data with the NAND flash memory NFMEM. The processor PROS and the SSD controller CTRL in the NAND flash memory NFMEM may be embodied as a single Advanced RISC Machines (ARM) processor. Data required to operate the processor PROS may be loaded to the RAM.

A host interface HOST I/F receives the request from the host, transmits the request to the processor PROS, or transmits data from the NAND flash memory NFMEM to the host. The host interface HOST I/F may interface the host by using one of various interface protocols including Universal Serial Bus (USB), Man Machine Communication (MMC), Peripheral Component Interconnect-Express (PCI-E), Serial Advanced Technology Attachment (SATA), Parallel Advanced Technology Attachment (PATA), Small Computer System Interface (SCSI), Enhanced Small Device Interface (ESDI), and Intelligent Drive Electronics (IDE). The data to be transmitted to or received from the NAND flash memory NFMEM may be temporarily stored in the cache buffer CBUF. The cache buffer CBUF may include an SRAM, a DRAM, and the like.

FIG. 19 is a block diagram illustrating a computing system CSYS according to an exemplary embodiment of the inventive concept.

Referring to FIG. 19, in the computing system CSYS, a processor CPU, a system memory RAM, and a semiconductor memory system MSYS may be electrically connected to each other via a bus. The semiconductor memory system MSYS includes a memory controller CTRL and a semiconductor memory device MEM. The semiconductor memory device MEM may store N-bit data (where N is an integer equal to or greater than 1) that has been processed or that is to be processed by the processor CPU. The semiconductor memory system MSYS of FIG. 19 may include one of the semiconductor storage systems 100 and 200 of FIGS. 1 and 2. The computing system CSYS of FIG. 19 may further include a user interface UI and a power supplying device PS that are electrically connected to the bus.

In a case where the computing system CSYS according to the one or more embodiments of the inventive concept is a mobile device, a battery for supplying an operation voltage to the computing system CSYS, and a modem including a baseband chipset may be additionally provided. Also, the computing system CSYS according to the one or more embodiments of the inventive concept may further include an application chipset, a camera image processor (CIS), a mobile DRAM, or the like.

While the inventive concept has been particularly shown and described with reference to exemplary embodiments thereof, it will be understood that various changes in form and details may be made therein without departing from the spirit and scope of the disclosure.

What is claimed is:

1. A semiconductor storage system comprising:
a plurality of buffer areas receiving data from an external source via a first interface unit;
a storage area receiving the data from the plurality of buffer areas and writing the received data via a second interface unit; and
a processor unit controlling the plurality of buffer areas and the storage area, the processor unit comprising a first processor controlling the first interface unit and a second processor controlling the second interface unit,
wherein the first processor comprises a delay unit for delaying a time at which the plurality of buffer areas receives the data from the external source via the first interface unit, and
wherein the length of the delay corresponding to a difference between a data reception speed of the plurality of buffer areas via the first interface unit and a data reception speed of the storage area via the second interface unit.

2. The semiconductor storage system of claim 1, wherein the processor unit further comprises a prediction unit predicting a length of time to take by the storage area to write the data received from the plurality of buffer areas.

3. The semiconductor storage system of claim 2, wherein, when the predicted length of time is equal to or greater than a predetermined value, the delay unit allows data to be received from the external source after a delay of a length of time corresponding to the reference value.

4. The semiconductor storage system of claim 3, wherein the predetermined value comprises two or more reference values, and the delay time varies according to the reference values.

5. The semiconductor storage system of claim 1, wherein the processor unit further comprises a counter for counting a number of buffer areas of the plurality of buffer areas to which no data is written.

6. The semiconductor storage system of claim 1, wherein the second processor comprises a measurement unit measuring a data exchange time between the plurality of buffer areas and the storage area.

7. The semiconductor storage system of claim 6, wherein, when the time measured by the measurement unit is equal to or greater than a predetermined value, the processor unit causes the data to be received from the external source after a delay of a length of time corresponding to the predetermined value.

8. The semiconductor storage system of claim 6, wherein, when the time measured by the measurement unit is increased, the processor unit controls the plurality of buffer areas to delay a time for receiving data from the external source by a length of time corresponding to the degree of the increased of the time measured by the measurement unit.

9. The semiconductor storage system of claim 1, wherein the semiconductor storage system is used in a real-time application.

10. The semiconductor storage system of claim 1, wherein the storage area comprises a solid state drive (SSD) or a hard disk drive (HDD).

11. The semiconductor storage system of claim 1, wherein the processor unit deletes the data from the plurality of buffer areas after the data is stored in the storage area.

12. A semiconductor storage system comprising:
a plurality of buffer areas receiving data from an external source via a first interface unit;
a storage area receiving the data from the plurality of buffer areas and writing the received data via a second interface unit; and
a processor controlling the plurality of buffer areas and the storage area and controlling the first interface unit and the second interface unit,
wherein the processor further comprises a delay unit for delaying a time at which the plurality of buffer areas receive the data from the external source via the first interface unit, and
wherein the length of the delay corresponding to a difference between a data reception speed of the plurality of buffer areas via the first interface unit and a data reception speed of the storage area via the second interface unit.

13. The semiconductor storage system of claim 12, wherein the processor comprises a prediction unit predicting a length of time to take by the storage area to write the data received from the plurality of buffer areas.

14. The semiconductor storage system of claim 12, wherein the processor comprises a counter for counting a number of buffer areas of the plurality of buffer areas to which no data is written.

15. The semiconductor storage system of claim 12, wherein the processor comprises a measurement unit measuring a data exchange time between the plurality of buffer areas and the storage area.

16. A system for storing data, comprising:
a first interface unit receiving data from an external source and sending the received data to a plurality of buffers;
a first processor controlling the first interface unit;
a second interface unit receiving the data from the plurality of buffers and writing the received data to a storage area; and
a second processor controlling the second interface unit,
wherein the first processor includes a delay unit for delaying the sending of the received data to a plurality of buffers by a length of time that corresponds to a difference between a speed by which the data is written to the storage unit and a speed by which the data is received by the external source.

17. The system of claim 1, wherein the delay unit delays the sending of the received data to the plurality of buffers by controlling the first interface unit.

18. The system of claim 1, wherein the length of time of the delay is calculated to equalize the speed by which the data is written to the storage unit and a speed by which the data is received by the external source.

19. The system of claim 1, wherein the speed by which the data is written to the storage unit is predicted by a prediction unit of the first processor.

20. The system of claim 1, wherein the speed by which the data is received by the external source is measured by a measurement unit of the second processor.
